(19) United States
(12) Patent Application Publication
(10) Pub. No.: US 2012/0106650 A1
(43) Pub. Date: May 3, 2012

(54) Method and System for Block and DVC Compression

(76) Inventors: Craig S. Siegman, Pembroke Pines, FL (US); Dana Wheeler, Deerfield Beach, FL (US)

(21) Appl. No.: 12/862,121

(22) Filed: Aug. 24, 2010

(51) Int. Cl. H04N 7/26

(52) U.S. Cl. 375/240.24; 375/E07.2

(57) ABSTRACT

Methods and systems are provided that combine Dambrackas Video Compression (DVC) with block video compression. When transmitting video frames that are changing, they determine which blocks have changed from frame to frame and transmit the information for the blocks that have changed. They apply DVC compression to the blocks that have changed, reducing the amount of data to be transmitted from frame to frame. Information regarding the blocks that have changed may be the only information transmitted, and the information transmitted in the changed blocks is compressed using DVC commands. These methods and systems may realize a combined benefit of block compression systems and DVC systems. These systems provide a way to enhance DVC so that only blocks of video data that have changed are encoded and compressed and thus fewer bytes of data will be sent to the client.

This generally relates to video compression and more particularly to block video compression and Dambrackas Video Compression systems.

### BACKGROUND

Video is made up of an array of pixels arranged in spatial and temporal dimensions. Video contains spatial redundancies within an individual frame, and temporal redundancies between frames. For example, spatial redundancy often occurs when adjacent pixels are the same or similar colors. Temporal redundancy often occurs when a pixel stays the same color for many frames of video, or only shifts its position as the camera moves. The quantity of data used to represent digital video images is reduced through video compression by removing these redundancies during transmission, effectively reducing the bandwidth required to transmit the video over a communication channel. Video compression is a tradeoff between disk space, video quality, and the cost of decompression hardware, with the end goal being fast and accurate transmission of video data.

There are numerous schemes for performing more efficient video compression. One of these solutions is Dambrackas Video Compression (DVC). DVC reduces the amount of data to transmit from a client to server to express video data from frame to frame. DVC is discussed in more detail in U.S. Pat. No. 7,321,623, entitled “Video Compression System,” which is incorporated by reference herein. DVC is a line and pixel oriented method of video compression that generally has five commands for expressing video data from frame to frame. Generally, these commands involve expressing whether a pixel or series of consecutive pixels in the new frame should be copied from an adjacent pixel of the previous frame (above or to the left), left the same as the same pixel in the previous frame, made to be series of two pixel colors, or made to be an individual pixel. This method provides an efficient way of transmitting frames of changing video data without needing to transmit all of the video data in the frame and thereby greatly increasing required bandwidth.

Additional conventional systems for video compression include block compression systems. These systems identify blocks that have changed in a frame, and transmit only the block that has changed. A block may be a portion of the frame that is, for example, 16×16 pixels or any other suitable size. As such, the frame will be made up of a number of blocks depending on the block and frame size. Some hardware systems have engines, e.g., snoop engines, that detect which blocks of a frame have changed from frame to frame. These block compression schemes may utilize this information to send only the video information for the blocks that have changed. However, these block schemes do not realize some of the compression benefits of the DVC compression system.

DVC, however, is a frame, line and pixel-oriented compression scheme that does not apply to blocks and does not utilize the advantages of an engine that detects changes in blocks from frame to frame. Whenever any part of the video screen changes, DVC encodes and compresses the entire video screen for transmission to a client. Because it encodes and compresses the entire screen, a small change on the video screen often results in a larger number of data bytes being sent to the client than is absolutely necessary.

Conventional systems to not realize the advantages of both block systems and DVC compression. Accordingly, there is a desire for a video compression system that realizes advantages of DVC compression as well as block compression.

### SUMMARY

In accordance with methods and systems consistent with the present invention, a method is provided in a data processing system for video compression, comprising examining a current video frame and a previous video frame, and determining which pixels in the current video frame changed from the previous video frame. The method further comprises determining a block size having a number of pixels in the current video frame, and determining which blocks of pixels in the current video frame changed from the previous video frame. The method also comprises encoding the pixels of the blocks that have changed in DVC protocol format, and transmitting the encoding of the blocks that have changed in the DVC protocol format, without transmitting the blocks of the current video frame that have not changed.

In one implementation, a method is provided in a data processing system for video compression, comprising determining a block size having a number of pixels in the current video frame, and receiving an encoding of blocks of a current video frame that have changed from a previous video frame without receiving blocks that have not changed. The method further comprises decoding the pixels of the blocks in DVC protocol format.

In another implementation, a data processing system is provided for video compression, comprising a processor configured to examine a current video frame and a previous video frame, determine which pixels in the current video frame changed from the previous video frame, and determine a block size having a number of pixels in the current video frame. The data processing system further comprises a block change detector configured to determine which blocks of pixels in the current video frame changed from the previous video frame. The data processing system also comprises an encoder configured to encode the pixels of the blocks that have changed in DVC protocol format, and transmit the encoding of the blocks that have changed in the DVC protocol format, without transmitting the blocks of the current video frame that have not changed.

### BRIEF DESCRIPTION OF THE DRAWINGS

FIG. 1 depicts an exemplary KVM computer system in accordance methods and systems consistent with the present invention.

FIG. 2 illustrates an exemplary client computer system consistent with systems and methods consistent with the present invention.

FIG. 3 depicts a flowchart illustrating exemplary steps in accordance with a method consistent with the present invention.

FIG. 4 depicts a frame having 4 blocks that have changed in accordance with methods and systems consistent with the present invention. In this example, a frame of a video is shown.

FIG. 5 depicts an exemplary frame having 4 blocks in a rectangular shape in accordance with methods and systems consistent with the present invention.

### DETAILED DESCRIPTION

Methods and systems in accordance with the present invention combine DVC compression with block compression. When transmitting video frames that are changing, they determine which blocks have changed from frame to frame and transmit the information for the blocks that have changed. In doing so, they apply DVC compression to the blocks that have changed, further realizing additional compression efficiency and reducing the amount of data to be transmitted from frame to frame. As such, information regarding the blocks that have changed may be the only information transmitted, and the information transmitted in the changed blocks is compressed using DVC commands, and as a result, the information transmitted is further reduced and made more efficient. These methods and systems may realize a combined benefit of block compression systems and DVC systems. These systems provide a way to enhance DVC so that only blocks of video data that have changed are encoded and compressed and thus fewer bytes of data will be sent to the client.

These systems may also take advantage of engines that detect block changes from frame to frame and the DVC compression protocol. If the engine indicates that a block or series of blocks is changed, there is no need to evaluate the entire frame nor transmit the entire frame. There is also no need to transmit the DVC commands and related information for the entire frame.

For example, if a set of four blocks in the middle of a frame has changed, methods and systems in accordance with the present invention may transmit the data for only those four blocks. Conventional DVC would typically transmit a no-change command for the entire screen up to the start of the first block, and then it would transmit the changes for the first line of the blocks, followed by a no-change command from the end of the blocks to the end of the line in the frame. Then for the next line, the DVC protocol would transmit a no-change command from the beginning of that line to the start of the first block and then the changes that have occurred on the same line in the block, followed by a no-change command from the end of the blocks to the end of that line in the frame. It would do so for each line in the blocks, and then transmit a no-change command from the end of the block to the end of the screen.

In this scenario, methods and systems in accordance with the present invention would identify which blocks have changed and identify how the information has changed within those changed blocks using the DVC commands to further reduce the total information that is transmitted to identify how to display the new frame. For a small number of changes in a video frame, or for multiple non-contiguous changes in a video frame, the block method can result in a substantial reduction in the number of data bytes sent to the client.

Reducing the number of bytes of data sent from the video encoder to the video client reduces network bandwidth and makes the solution more efficient. Some video controllers from manufacturers such as Nuvoton and ServerEngines contain video change engines that work on a block basis. Existing DVC does not take full advantage of these change engines because the protocol is line-oriented. By integrating a block method, DVC can take advantage of these change engines and reduce the CPU cycles needed to detect and determine changes to the video and reduce network bandwidth usage by reducing the number of DVC commands sent to indicate changes to the video display.

DVC was a substantial step forward in reducing the amount of data sent from the video encoder to the video client. Methods and systems in accordance with the present invention further reduce the number of video data bytes processed and sent. DVC typically comprises five different types of single or multi-byte commands: Make Pixel (MP); Make Series (MS); No Change (NC); Copy Left (CL); and Copy Above (CA). These DVC commands and other aspects of DVC are discussed in detail in U.S. Pat. No. 7,321,623. DVC is also discussed in U.S. Patent Application Publication No. 2007/0253492 which is incorporated by reference herein. In one implementation, these commands are used and are not modified. In one implementation, methods and systems in accordance with the present invention add three new commands to DVC. They may also implement a change to a transport protocol for DVC, typically the Avocent Video Session Protocol (AVSP). AVSP may be modified so that it indicates whether the frame of DVC data it is transporting is in the pixel block format. If the DVC data is in the regular frame format, then no change to AVSP is needed.

Once changed blocks of a frame are identified, the blocks are encoded with the three new commands. Other suitable commands may be used, and the commands are not limited to these three. Generally, the blocks are identified in the commands by a single block, a row of contiguous blocks, or an area of blocks forming a rectangle. The first new DVC command, Block Number Singular (BNS) indicates for which particular block the following DVC data is being sent. The second new DVC command, Block Number Multiple (BNM) indicates the starting block and the number of contiguous blocks (after the first block) it applies to for which DVC data is being sent. In one implementation, the blocks are numbered starting at zero in the upper left and proceeding left to right and then top to bottom. The size of each block may be determined prior to the start of DVC transmissions and may be part of the encompassing protocol over which DVC data is sent such as AVSP. The third new command, Block Number Rectangular (BNR) indicates the starting block and the number of blocks in the horizontal and vertical dimensions that make up a rectangle of blocks. Typically, blocks may be 16×16 pixels or 32×32 pixels in size, but any other size may also be used.

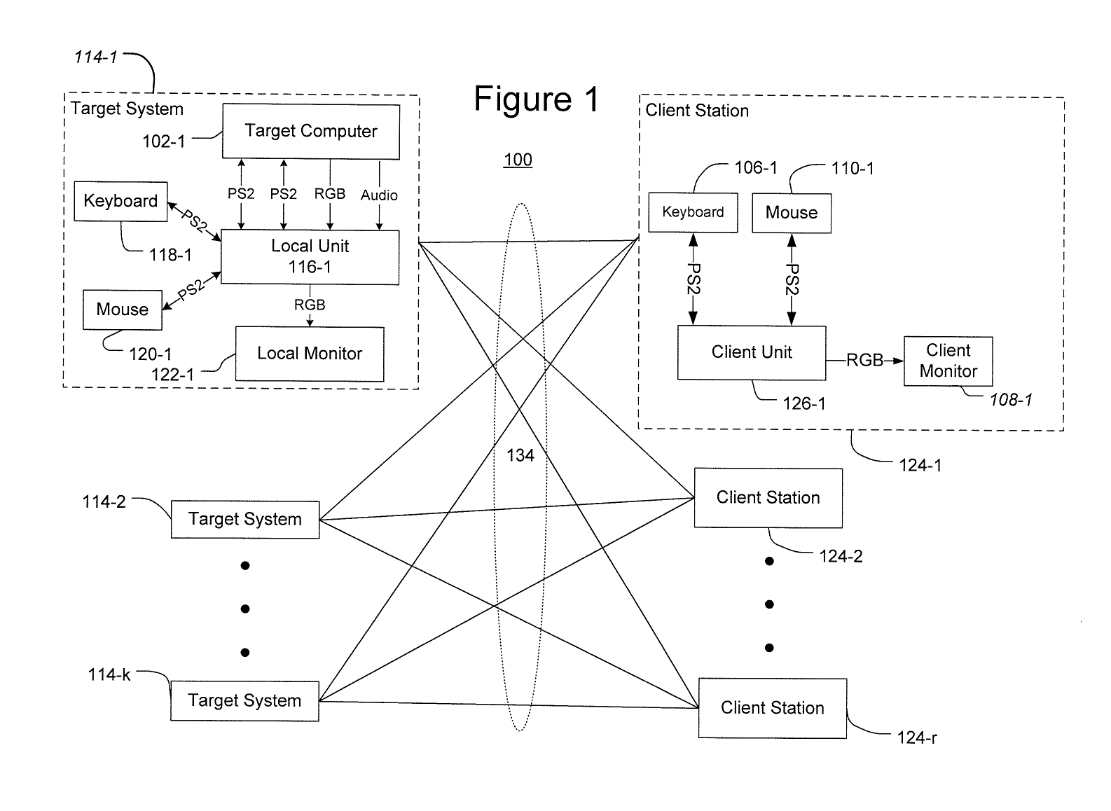

FIG. 1 depicts an exemplary KVM computer system in accordance methods and systems consistent with the present invention. These systems may implement DVC video compression over a network between a client and target computer system. A KVM system 100 is shown in FIG. 1, where one or more target systems 114-1 . . . 114-k are controlled or accessed by one or more client stations 124-1, 124-2, . . . , 124-r (generally 124). Each target system 114 includes a target computer 102 with associated and attached local unit 116. Each client station 124 generally includes a client unit 126, a keyboard 106, a video monitor 108, and a mouse (or similar point-and-click device) 110, although some client stations may only include a video display 108 and a client unit. Operation of a particular target computer 102-i may be remotely viewed on the video monitor 108 of any of the client stations 124, and the keyboard 106 and mouse 110 of the client station 124 may be used to provide keyboard and mouse input to the target computer 102-i. As shown in FIG. 1, in a KVM system 100, a client station 124 is able to control or access more than one target computer. Note that the lines drawn between target systems and client stations in FIG. 1 represent potential (and not necessarily actual) wired or wireless (e.g., RF) links between those sides. Thus, each target computer 102 may be controlled or accessed by more than one client station 124, and each client station 124 may control more than one target computer 102. The client station, in one implementation, may be located within several hundred feet of the target system.

Furthermore, in certain contexts, the target system is considered to be a video transmitter or sending unit, and the client system is the video receiving unit or receiver, although both units transmit and receive. Generally, video travels from target system to client station, while keyboard and mouse data move from client station to target system.

As shown in FIG. 1 the local or target system 114 includes a target computer 102 and an associated local unit 116. The local system 114 may also include a keyboard 118, a mouse (or other point-and-click-type device) 120 and a local monitor 122, each connected to the local unit 116 directly. The client station 124 includes a client unit 126. The local or target computer 102 may be a computer, a server, a processor or other collection of processors or logic elements. Generally, a target computer may include any processor or collection of processors. By way of example, a target computer may be a processor or collection of processors or logic elements located (or embedded) in a server, a desktop computer (such as a PC, Apple Macintosh or the like), a kiosk, an ATM, a switch, a set-top box, an appliance (such as a television, DVR, DVD player and the like), a vehicle, an elevator, on a manufacturing or processing production line. A collection of target computers may be a collection of servers in a rack or some other collection, and they may be independent of each other or connected to each other in a network or by some other structure. The local and client monitors 122, 108, may be digital or analog.

The local unit 116 is a device or mechanism, e.g., a printed circuit board (“PCB”), that is installed locally to the target/local computer 102. This device may be close to, but external to the computer, or may be installed inside the computer's housing. Regardless of the positioning of the local unit 116, in one implementation, there is a direct electrical connection between the target computer 102 and the local unit 116.

Various components on the local/target system 114 communicate wirelessly or via a wired connection with components on the client station 124 via a wireless connection link 134. In one implementation, the wireless connection or link 134 follows the IEEE 802.11a standard protocol, although one skilled in the art will realize that other protocols and methods of communication are possible.

The local unit 116 receives local mouse and keyboard signals, e.g., as PS2 signals. These signals are provided by the local unit 116 to the target computer 102. The target computer 102 generates video output signals, e.g., RGB (Red, Green, Blue) signals, which are provided to the local unit 116 which, in turn, provides the signals to drive the local monitor 122. The target computer 102 may also generate audio output signals which are provided to the local unit 116. As noted, the target computer 102 need not have a keyboard, mouse or monitor, and may be controlled entirely by a client station 124.

Local unit 116 transmits image data for transmission to a client station (e.g., via client unit 126). Some or all of the data may be compressed before being transmitted. Additionally, local unit 116 may receive mouse and keyboard data (from a client station 124), which is then provided to the local/target computer 102. The target computer 102 may execute the data received and may display output on its local monitor 122.

The client station 124 receives video data from the local unit 116 of the target computer 102, via a wired or wireless connection (e.g., 802.11a wireless connection 134). The client unit 126 receives (possibly compressed) video data (not all of the data need be compressed) from the local unit 116. The client unit 126 decompresses (as necessary) the video data from the local unit 116 and provides it to the appropriate rendering device, e.g., to the client monitor 108, which displays the video data. Additionally, client mouse 110 and keyboard 106 may be used to generate appropriate signals (e.g., PS2 signals) that may be transmitted via client unit 126 to local unit 116 for execution on target computer 102.

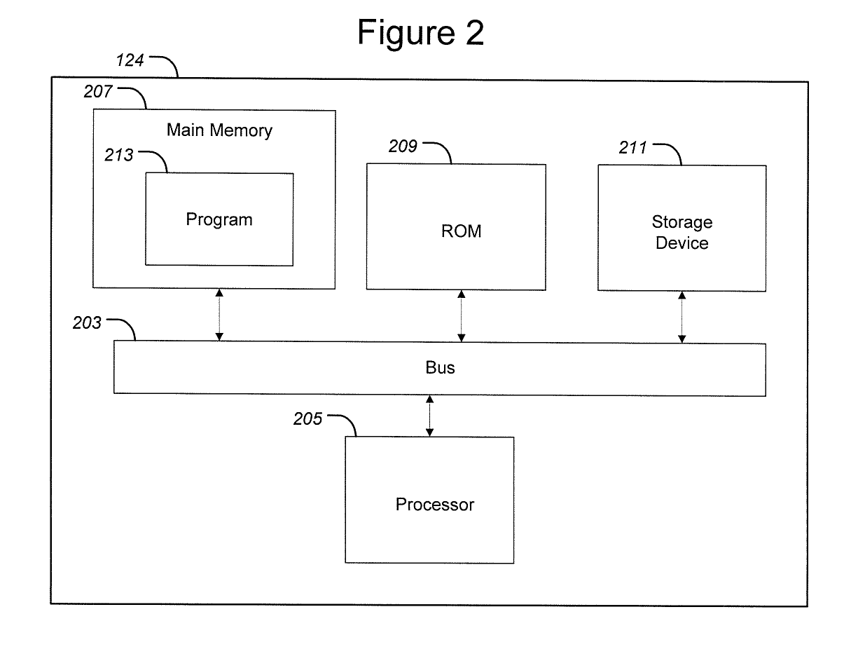

FIG. 2 illustrates an exemplary client computer system consistent with systems and methods consistent with the present invention. Client computer 124 includes a bus 203 or other communication mechanism for communicating information, and a processor 205 coupled with bus 203 for processing the information. Processor 205 or another video processing component may implement the block and DVC encoding and decoding described herein. Client station 124 may also include similar components as client computer 124, including some or all of the components mentioned. Client computer 124 also includes a main memory 207, such as a random access memory (RAM) or other dynamic storage device, coupled to bus 203 for storing information and instructions to be executed by processor 205. In addition, main memory 207 may be used for storing temporary variables or other intermediate information during execution of instructions to be executed by processor 205. Main memory 207 includes a program 213 for implementing processing consistent with methods and systems in accordance with the present invention. Client computer 124 further includes a Read-Only Memory (ROM) 209 or other static storage device coupled to bus 203 for storing static information and instructions for processor 205. A storage device 211, such as a magnetic disk or optical disk, is provided and coupled to bus 203 for storing information and instructions.

According to one embodiment, processor 205 executes one or more sequences of one or more instructions contained in main memory 207. Such instructions may be read into main memory 207 from another computer-readable medium, such as storage device 211. Execution of the sequences of instructions in main memory 207 causes processor 205 to perform processes described herein. One or more processors in a multi-processing arrangement may also be employed to execute the sequences of instructions contained in main memory 207. In alternative embodiments, hard-wired circuitry may be used in place of or in combination with software instructions. Thus, embodiments are not limited to any specific combination of hardware circuitry and software.

Although described relative to main memory 207 and storage device 211, instructions and other aspects of methods and systems consistent with the present invention may reside on another computer-readable medium, such as a floppy disk, a flexible disk, hard disk, magnetic tape, a CD-ROM, magnetic, optical or physical medium, a RAM, a PROM, and EPROM, a FLASH-EPROM, any other memory chip or cartridge, or any other medium from which a computer can read, either now known or later discovered.

Additionally, any of the systems described in U.S. Pat. No. 7,321,623 may be used and/or adapted for use with methods and systems in accordance with the present invention.

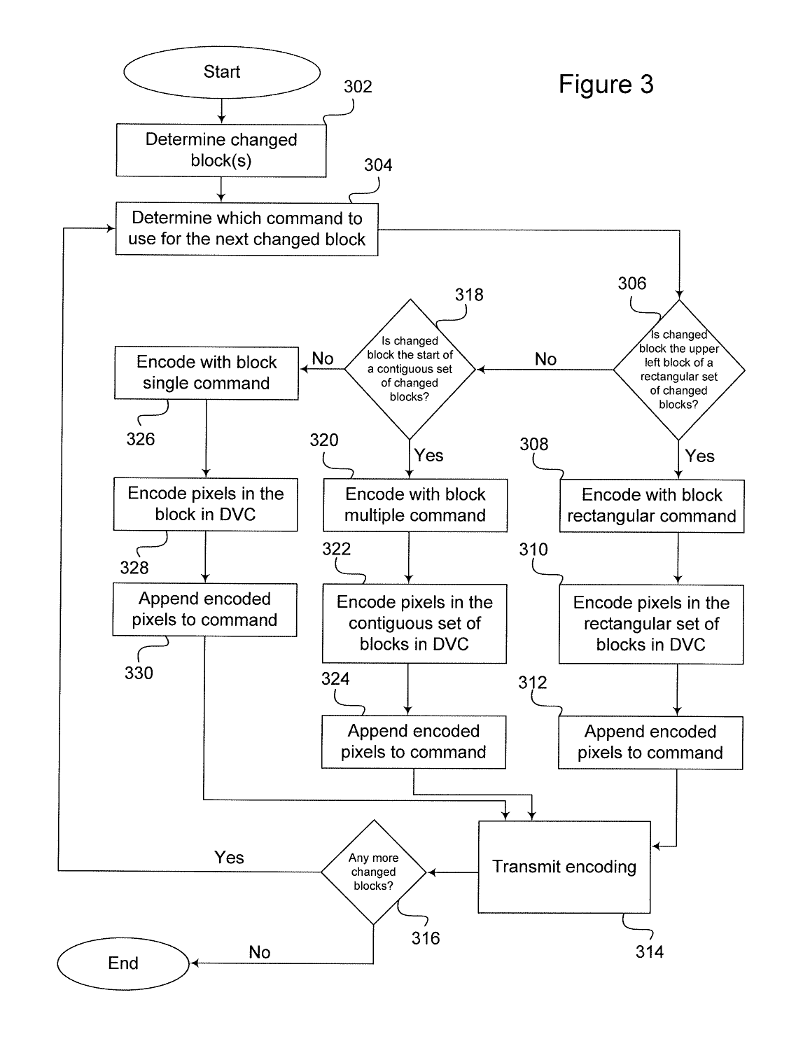

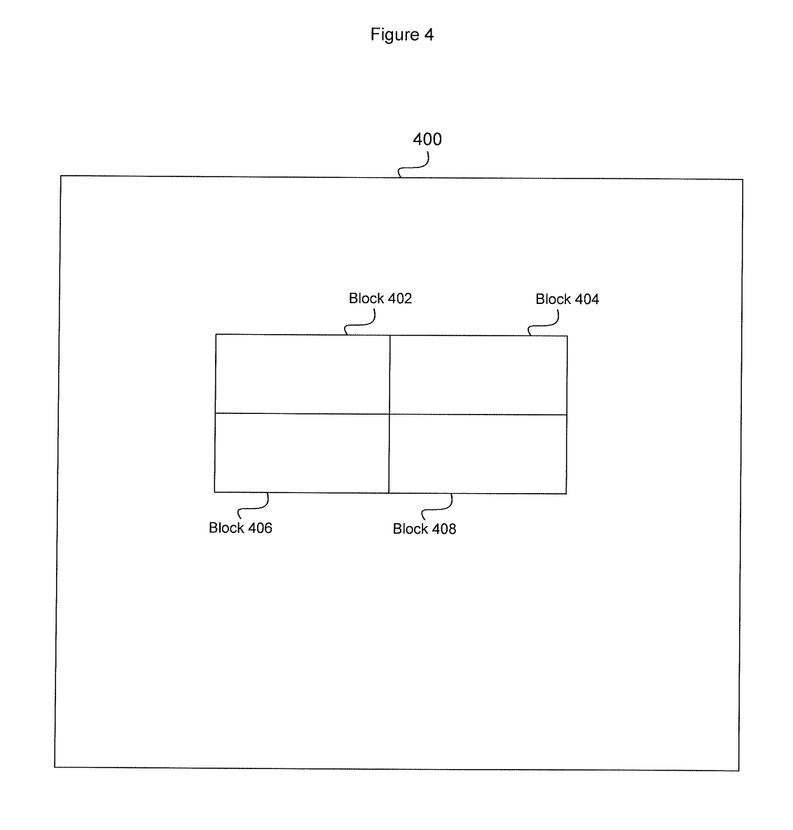

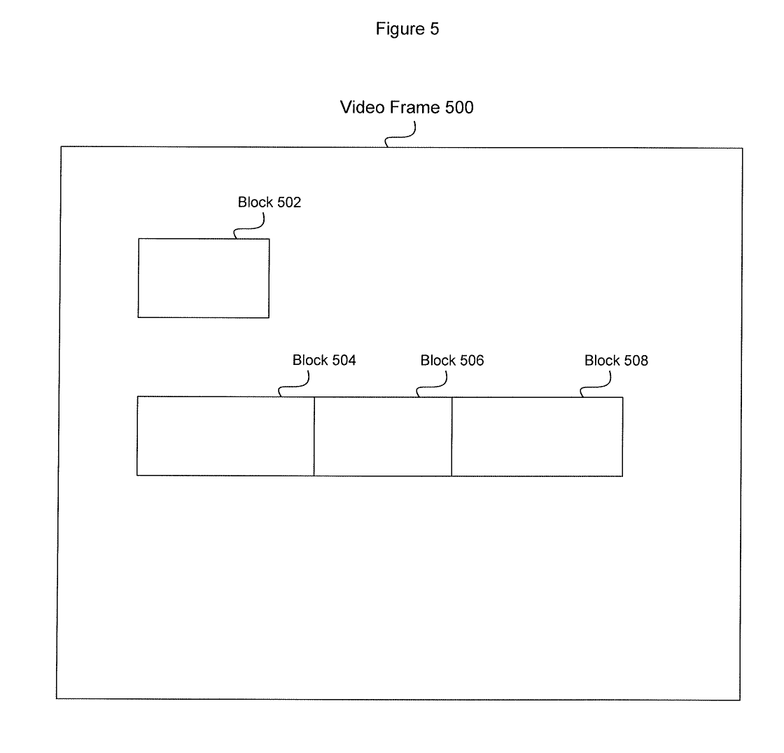

FIG. 3 depicts a flowchart illustrating exemplary steps in accordance with a method consistent with the present invention. The steps of FIG. 3 will be discussed in conjunction with FIGS. 4 and 5 below.

FIG. 4 depicts a frame having 4 blocks that have changed in accordance with methods and systems consistent with the present invention. In this example, a frame of a video is shown. The frame is divided into many blocks of equal size, e.g., 16×16 pixels. In this figure, only blocks that have changed from the previous video frame are shown and the blocks may not be to scale as shown. There may be many more blocks, changed or unchanged, than the blocks shown. For example, the previous frame was sent, and then the new frame changed in just blocks 402-408. To encode the video frame for transmission, a snoop engine detects the changed blocks 402-408 (step 302). Then the system determines which command is appropriate for each changed block or set of blocks (step 304).

In particular, FIG. 4 depicts an exemplary frame having 4 blocks in a rectangular shape in accordance with methods and systems consistent with the present invention. In this example, the snoop engine detects that the blocks 402-408 have changed from the video frame previous to video frame 400 (step 302). The system may check to see if a changed block is the beginning of a rectangular set of changed blocks (step 306). After detecting blocks in a rectangular format, e.g., blocks 402-408, it encodes the pixels in the rectangular box of blocks in the DVC protocol. It does so as if the various blocks in the rectangular box were one single larger block. In this case, the Block Rectangular command is used and identifies the blocks in the box 402-408 (step 308). It should be noted that although the blocks shown in FIG. 4 form a square, any rectangular may be detected. In one implementation, the snoop engine identifies the block by indicating the starting block number, e.g., block 402, followed by the number of blocks in horizontal direction, e.g., 2, and the number of blocks in the vertical direction, e.g., 2. For example, the command may include Block Rectangular for block 402 with 2 blocks in the horizontal direction and 2 blocks in the vertical direction, where the blocks are 402-408 form the rectangular block having changes detected in the frame. The pixels in the block, e.g., 32×32 pixels, are encoded using the DVC protocol (step 310). This encoding results in a series of various appropriate DVC commands which describe the video data to be rendered, and in one implementation, are just the pixels in that rectangular block form by blocks 402-408. These DVC commands may be appended to the Block Rectangular command which indicates which blocks are changing (step 312). This conveys the information to render the blocks by the receiving component. In one implementation, the system repeats this encoding for all sets of rectangular blocks that have changed in the frame (step 306). The system may send the encoding to the receiving component when the encoding is complete or as the encoding progresses (step 314). The system checks for more changed blocks (step 316), and if there are more, it determines the command to use for those blocks (step 304).

FIG. 5 depicts an exemplary frame having four changed blocks including one single changed block and three changed blocks in a row. In this example, the system detects a row of blocks 504-508 that has changed by detecting that a changed block is the first block in a row of changed blocks (step 318). After detecting a row of blocks, it encodes the pixels in the row of blocks in the DVC protocol. It does so as if the various blocks in the row were one single larger rectangular block. In this case, the Block Multiple command is used and identifies the blocks in the row 404-408 (step 320). In one implementation, it does so by indicating the starting block number, e.g., block 504, followed by the number of blocks in the sequential row, e.g., 3. For example, the command may include Block Multiple for block number 60 with a total of 3 blocks, where the blocks are 504-508 are the 60th, 61^{st} and 62^{nd} blocks in the frame. The pixels in the block, e.g., 16×48 pixels, are encoded using the DVC protocol (step 322). This encoding results in a series of various appropriate DVC commands which describe the video data to be rendered, and in one implementation, are just the pixels in that rectangular block form by blocks 504-508. These DVC commands may be appended to the Block Multiple command which indicates which blocks are changing (step 324). This encodes and conveys the information to render the blocks by the receiving component. In one implementation, the system repeats this encoding for all contiguous blocks that have changed in the frame (step 318). The system may send the encoding to the receiving component when the encoding is complete or as the encoding progresses (step 314). The system checks for more changed blocks (step 316), and if there are more, it determines the command to use for those blocks (step 304).

For the single changed block 502, the system encodes the change with a Block Single command indicating which single block has changed (step 326). For example, this command may include Block Single for block number 45 (when block 502 is block number 45 in the frame). The pixels in the block, e.g., 16×16 pixels, are encoded using the DVC protocol (step 328). This results in a series of various appropriate DVC commands (e.g., Make Pixel (MP), Make Series (MS), No Change (NC), Copy Left (CL), and Copy Above (CA)) which describe the video data to be rendered, and in one implementation, are just the pixels in that block 502. (Alternatively, pixels outside the specified block may be used as a reference for DVC copy commands. For example, if the pixel just to the left of the pixel in the upper left corner of the block is identical to the first pixel in the first row of the block, then a copy left command can be done for the first pixel in the block.) These DVC commands may be appended to the Block Single command which indicates which block is changing (step 330). This encodes and conveys the information to render the block by the receiving component. In one implementation, the system repeats this encoding for all single blocks that have changed in the frame. The system may send the encoding to the receiving component when the encoding is complete or as the encoding progresses (step 314). The system checks for more changed blocks (step 316), and if there are more, it determines the command to use for those blocks (step 304).

The receiving component may receive the commands, e.g., Block Single, Block Multiple, Block Rectangular, and decode them accordingly to render the video for display. The indicators after the block commands are interpreted to determine which blocks are being received, and then the decoder may use the DVC commands that follow to decode the pixels within those changed blocks.

The foregoing description of various embodiments provides illustration and description, but is not intended to be exhaustive or to limit the invention to the precise form disclosed. Modifications and variations are possible in light of the above teachings or may be acquired from practice in accordance with the present invention. It is to be understood that the invention is intended to cover various modifications and equivalent arrangements included within the spirit and scope of the appended claims.

What is claimed is:

1. A method in a data processing system for video compression, comprising:
examining a current video frame and a previous video frame;
determining which pixels in the current video frame changed from the previous video frame;
determining a block size having a number of pixels in the current video frame;
determining which blocks of pixels in the current video frame changed from the previous video frame;
encoding the pixels of the blocks that have changed in DVC protocol format; and
transmitting the encoding of the blocks that have changed in the DVC protocol format, without transmitting the blocks of the current video frame that have not changed.

2. The method of claim 1, receiving the encoding of the blocks that have changed; and
decoding the encoding of blocks that have changed.

3. The method of claim 1, further comprising:
displaying an image based on the decoding of the encoding of blocks that have changed.

4. The method of claim 1, wherein the encoding further comprises:
encoding a single block of pixels of the current video frame.

5. The method of claim 4, wherein encoding a single block of pixels further comprises:
encoding the single block of pixels of the current video frame by identifying the block and DVC commands to encode the pixels within the block.

6. The method of claim 1, wherein the encoding further comprises:
encoding a set of contiguous blocks of pixels of the current video frame.

7. The method of claim 5, wherein encoding a set of contiguous blocks further comprises:
encoding the set of contiguous blocks of pixels of the current video frame by identifying a first block in the set, a number of blocks in the set, and DVC commands to encode the pixels within the set of contiguous blocks.

8. The method of claim 1, wherein the encoding further comprises:
encoding a rectangular set of blocks of pixels of the current video frame.

9. The method of claim 1, wherein encoding a rectangular set of blocks of pixels further comprises:
encoding the rectangular set of blocks of pixels of the current video frame by identifying a first block, a horizontal number of blocks in the set, a vertical number of blocks in the set, and the DVC commands to encode the pixels within the block.

10. The method of claim 1, wherein encoding in the DVC compression protocol comprises:
encoding the pixel data using one or more commands of: Make Pixel (MP); Make Series (MS); No Change (NC); Copy Left (CL); and Copy Above (CA).

11. A method in a data processing system for video compression, comprising:
determining a block size having a number of pixels in the current video frame;
receiving an encoding of blocks of a current video frame that have changed from a previous video frame without receiving blocks that have not changed; and
decoding the pixels of the blocks in DVC protocol format.

12. The method of claim 11, further comprising
displaying an image based on the decoding.

13. The method of claim 11, further comprising
receiving an encoding of a single block; and
decoding DVC commands to decode the pixels within the single block.

14. The method of claim 11, wherein the encoding further comprises:
receiving an encoding of a set of contiguous blocks of pixels of the current video frame; and
decoding DVC commands to decode the pixels within the set of contiguous blocks.

15. The method of claim 14, wherein decoding a set of contiguous blocks further comprises:
decoding the set of contiguous blocks of pixels of the current video frame by receiving identification of a first block in the set, a number of blocks in the set, and DVC commands to encode the pixels within the set of contiguous blocks.

16. The method of claim 11, wherein the decoding further comprises:
encoding a rectangular set of blocks of pixels of the current video frame.

17. The method of claim 16, wherein decoding a rectangular set of blocks of pixels further comprises:
receiving an encoding of a rectangular set of blocks of pixels of the current video frame; and
decoding DVC commands to decode the pixels within the rectangular set of blocks of pixels of the current video frame.

18. A data processing system for video compression, comprising:
a processor configured to:
examine a current video frame and a previous video frame;
determine which pixels in the current video frame changed from the previous video frame;
determine a block size having a number of pixels in the current video frame;
a block change detector configured to:
determine which blocks of pixels in the current video frame changed from the previous video frame; and
an encoder configured to:
encode the pixels of the blocks that have changed in DVC protocol format; and
transmit the encoding of the blocks that have changed in the DVC protocol format, without transmitting the blocks of the current video frame that have not changed.
